(19) United States
(12) Patent Application Publication
(10) Pub. No.: US 2012/0159999 A1
(43) Pub. Date: Jun. 28, 2012

(54) DETERGENT CASE AND WASHING MACHINE HAVING THE SAME

(75) Inventors: Seok In HONG, Suwon-si (KR); Do Yeon KIM, Seoul (KR); Chan Woo PARK, Anyang-si (KR)

(73) Assignee: Samsung Electronics Co., Ltd., Suwon-si (KR)

(21) Appl. No.: 13/324,541

(22) Filed: Dec. 13, 2011

(30) Foreign Application Priority Data
Dec. 27, 2010 (KR) 10-2010-0135806

(51) Int. Cl. D06F 39/02; B67D 7/84

(52) U.S. Cl. 68/17 R; 222/173

(57) ABSTRACT

A detergent case improved so that a liquid detergent stored therein is effectively discharged to the outside of the detergent case, and a washing machine having the same. The washing machine includes a main body, a drum disposed in the main body, and a detergent case mounted in the main body to supply a detergent to the inside of the drum, wherein the detergent case includes a liquid detergent storage part to store a liquid detergent, a siphon pipe protruded from the bottom of the liquid detergent storage part and including first flow paths divided into at least two spaces, and a siphon cap connected to the outer portion of the siphon pipe and forming second flow paths divided into at least two spaces.

### CROSS-REFERENCE TO RELATED APPLICATIONS

This application claims the priority benefit of Korean Patent Application No. 10-2010-0135806, filed on Dec. 27, 2010 in the Korean Intellectual Property Office, the disclosure of which is incorporated herein by reference.

### BACKGROUND

1. Field

Embodiments relate to a detergent case and a washing machine having the same.

2. Description of the Related Art

In general, a washing machine is an apparatus which washes laundry by rotating a cylindrical spin basket in which the laundry and wash water are placed. Washing machines are divided into a drum washing machine in which a spin basket, i.e., a drum, is horizontally disposed and laundry is lifted and fallen along the inner circumferential surface of the drum and thus washed when the drum is rotated in regular and reverse directions with respect to a horizontal axis, and a pulsator washing machine in which a spin basket provided with a pulsator formed therein is vertically disposed and laundry is washed using a water current generated by the pulsator when the spin basket is rotated in regular and reverse directions with respect to a vertical axis.

A detergent case which enables a detergent to be dissolved in wash water supplied to the inside of the spin basket from an external water supply source and supplies the wash water containing the detergent to the inside of the spin basket is installed at the upper portion of the drum washing machine or the pulsator washing machine.

The detergent case includes a solid detergent storage part to store a detergent in a powdery state composed of fine particles and a liquid detergent storage part to store a detergent in a liquid state or a fabric softener. Particularly, the liquid detergent storage part is provided with a structure using siphonage so that the liquid detergent mixed with wash water is effectively supplied to the inside of the spin basket.

### SUMMARY

Therefore, it is an aspect of one or more embodiments to provide a detergent case which is improved so that a liquid detergent stored therein is effectively discharged to the outside of the detergent case, and a washing machine having the same.

Additional aspects of one or more embodiments will be set forth in part in the description which follows and, in part, will be apparent from the description, or may be learned by practice of the invention.

In accordance with one aspect of one or more embodiments, a washing machine includes a main body, a drum disposed in the main body, and a detergent case mounted in the main body to supply a detergent to the inside of the drum, wherein the detergent case includes a liquid detergent storage part to store a liquid detergent, a siphon pipe protruded from the bottom of the liquid detergent storage part and including first flow paths divided into at least two spaces, and a siphon cap connected to the outer portion of the siphon pipe and forming second flow paths divided into at least two spaces.

The second flow paths may be formed between the outer circumferential surface of the siphon pipe and the inner circumferential surface of the siphon cap so that the liquid detergent stored in the liquid detergent storage part flows upward, and the first flow paths may communicate with the second flow paths and be formed at the inside of the siphon pipe so that the liquid detergent having passed through the second flow paths falls to the inside of the drum.

The washing machine may further include a plurality of partition ribs to divide the siphon pipe, and the plurality of partition ribs may include inner ribs disposed at the inside of the siphon pipe to divide the first flow paths from each other, and outer ribs disposed between the outer circumferential surface of the siphon pipe and the inner circumferential surface of the siphon cap to divide the second flow paths from each other.

The plurality of partition ribs may be formed to a greater height than the siphon pipe and thus contacts the inner surface of the siphon cap.

Each of the outer ribs may include a holding groove in which the siphon cap is held.

The first flow paths and the second flow paths may be respectively divided into at least two spaces having different cross-sectional areas.

The plurality of partition ribs may be extended radially from the center of the siphon pipe, and at least one interval between the neighboring plurality of partition ribs may be different.

A thickness of at lease one of the plurality of partition ribs may be different.

A thickness of at least one part of the siphon pipe divided by the plurality of partition ribs may be different.

A thickness of at least one part of the siphon cap divided by the plurality of partition ribs may be different.

In accordance with another aspect of one or more embodiments, a detergent case mounted in a main body of a washing machine to store a detergent includes a liquid detergent storage part provided with a discharge hole to discharge a liquid detergent, and a liquid detergent discharge device communicating with the discharge hole and provided with at least two liquid detergent discharge paths divided from each other.

The liquid detergent discharge device may include a liquid detergent discharge pipe provided at a position corresponding to the discharge hole so as to communicate with the discharge hole and including first flow paths divided into at least two spaces, and a discharge pipe cap connected to the liquid detergent discharge pipe and forming second flow paths divided into at least two spaces.

The first flow paths may be formed at the inside of the liquid detergent discharge pipe, and the second flow paths may be provided between the outside of the liquid detergent discharge pipe and the inside of the discharge pipe cap.

The liquid detergent discharge pipe may further include a plurality of partition ribs to divide the first flow paths into at least two spaces having different cross-sectional areas, and the plurality of partition ribs may be extended radially from the center of the liquid detergent discharge pipe and contact the inner circumferential surface of the discharge pipe cap.

The plurality of partition ribs may pass through the side surface of the liquid detergent discharge pipe and divide the second flow paths into at least two spaces having different cross-sectional areas.

The plurality of partition ribs may be formed to a greater height than the liquid detergent discharge pipe and contacts the discharge pipe cap.

Each of the plurality of partition ribs may include a holding part protruded upward from the bottom surface of the liquid detergent storage part so as to separate the discharge pipe cap from the bottom surface.

A holding groove to prevent movement of the discharge pipe cap may be provided on the holding part.

The discharge pipe cap may be connected to the holding groove to form a liquid detergent inflow hole through which the liquid detergent stored in the liquid detergent storage part flows into the second flow paths.

### BRIEF DESCRIPTION OF THE DRAWINGS

These and/or other aspects of one or more embodiments will become apparent and more readily appreciated from the following description of embodiments, taken in conjunction with the accompanying drawings of which:

FIG. 1 is a cross-sectional view illustrating a configuration of a washing machine in accordance with an embodiment;

FIG. 2 is an exploded view illustrating a detergent case provided in the washing machine in accordance with an embodiment;

FIG. 3 is an exploded view illustrating a liquid detergent discharge device extracted from FIG. 2;

FIG. 4 is a cross-sectional view taken along line I-I of FIG. 3;

FIG. 5 is a cross-sectional view taken along line II-II of FIG. 4;

FIG. 6 is a cross-sectional view illustrating a state in which intervals between partition ribs are different from FIG. 5;

FIG. 7 is a cross-sectional view illustrating a state in which thicknesses of the partition ribs are different from FIG. 5;

FIG. 8 is a cross-sectional view illustrating a state in which thicknesses of parts of a siphon pipe divided by the partition ribs are different from FIG. 5; and

FIG. 9 is a cross-sectional view illustrating a state in which thicknesses of parts of a siphon cap divided by the partition ribs are different from FIG. 5.

### DETAILED DESCRIPTION

Reference will now be made in detail to embodiments, examples of which are illustrated in the accompanying drawings, wherein like reference numerals refer to like elements throughout.

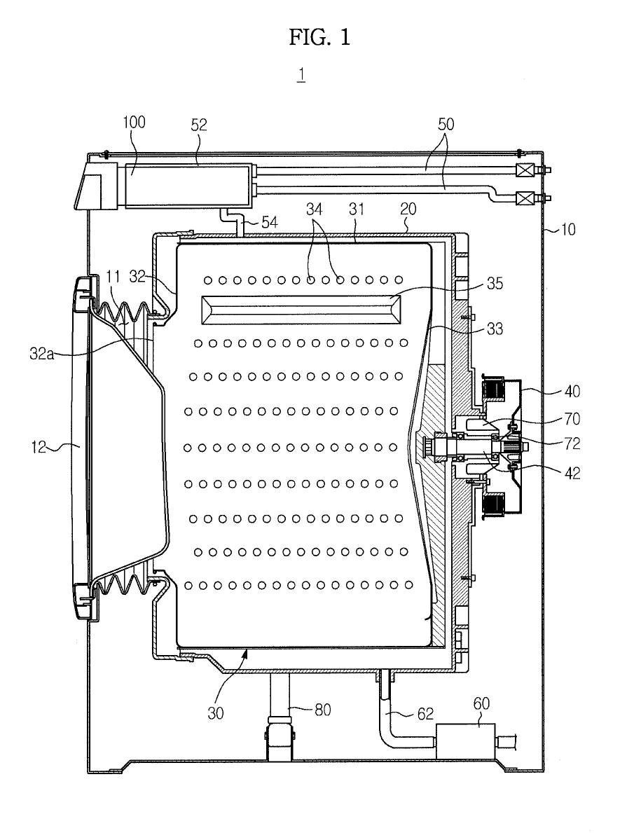

FIG. 1 is a cross-sectional view illustrating a configuration of a washing machine in accordance with an embodiment.

As shown in FIG. 1, a washing machine 1 includes a cabinet 10 forming the external appearance of the washing machine 1, a tub 20 disposed in the cabinet 10, a drum 30 rotatably disposed in the tub 20, and a motor 40 to rotate the drum 30.

An inlet 11 is formed through the front surface of the cabinet 10 so that laundry may be put into the drum 30 through the inlet 11. The inlet 11 is opened and closed by a door 12 installed on the front surface of the cabinet 10.

Water supply hoses 50 to supply wash water to the tub 20 are installed above the tub 20. One end of each of the water supply hoses 50 is connected to an external water supply source (not shown), and the other end of each of the water supply hoses 50 is connected to a detergent supply device 52.

The detergent supply device 52 is connected to the tub 20 through a connection pipe 54, and includes a detergent case 100 to store a detergent or a fabric softener. Water supplied through the water supply hoses 50 passes through the detergent case 100 and is mixed with the detergent and the fabric softener, and then the water containing the detergent or the fabric softener is supplied to the inside of the tub 20.

The tub 20 is supported by dampers 80. The dampers 80 connect the inner lower surface of the cabinet 10 to the outer surface of the tub 20.

A drain pump 60 and a drain pipe 62 to discharge water in the tub 20 to the outside of the cabinet 10 are installed under the tub 20.

The drum 30 includes a cylindrical member 31, a front plate 32 disposed at the front part of the cylindrical member 31, and a rear plate 33 disposed at the rear part of the cylindrical member 31. An opening 32a to enable laundry to be put into or taken out of the drum 30 is formed through the front plate 32, and a drive shaft 42 to transmit power of the motor 40 is connected to the rear plate 33.

A plurality of through holes 34 to circulate wash water is formed through the circumferential surface of the drum 30, and a plurality of lifters 35 to lift and fall laundry when the drum 30 is rotated is installed on the inner circumferential surface of the drum 30.

The drive shaft 42 is disposed between the drum 30 and the motor 40. One end of the drive shaft 42 is connected to the rear plate 33 of the drum 30, and the other end of the drive shaft 42 is extended to the outside of the rear wall of the tub 20. When the motor 40 drives the drive shaft 42, the drum 30 connected to the drive shaft 42 is rotated around the drive shaft 42.

A bearing housing 70 is installed on the rear wall of the tub 20 so as to rotatably support the drive shaft 42. The bearing housing 70 may be an aluminum alloy and be inserted into the rear wall of the tub 20 when the tub 20 is formed by injection molding. Bearings 72 are installed between the bearing housing 70 and the drive shaft 42 so as to effectively rotate the drive shaft 42.

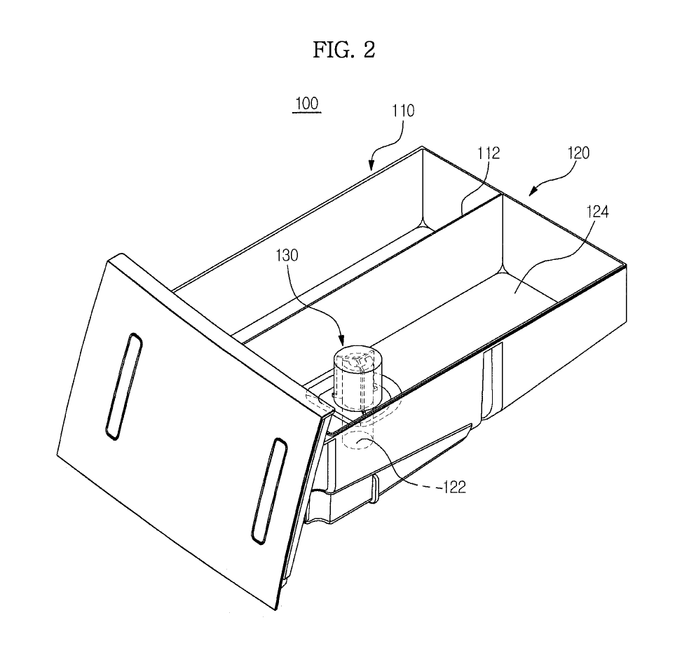

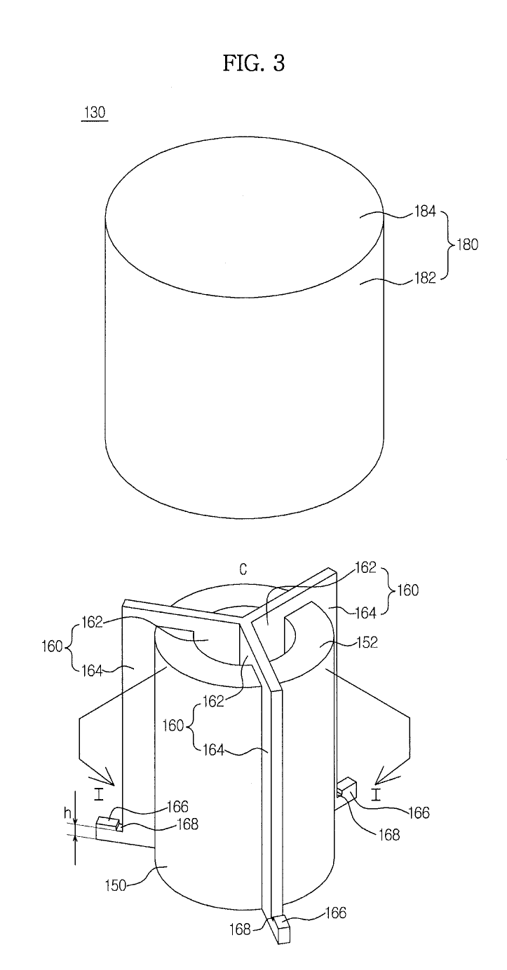

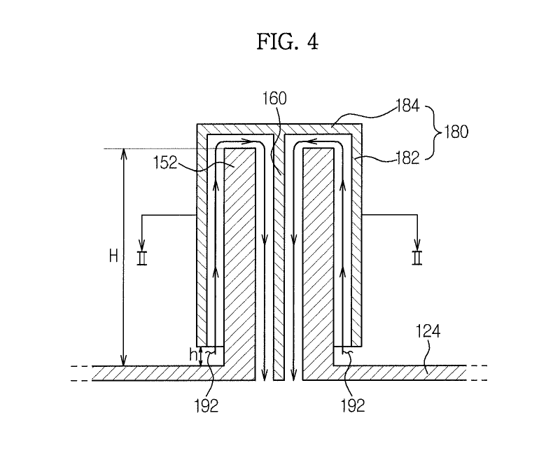

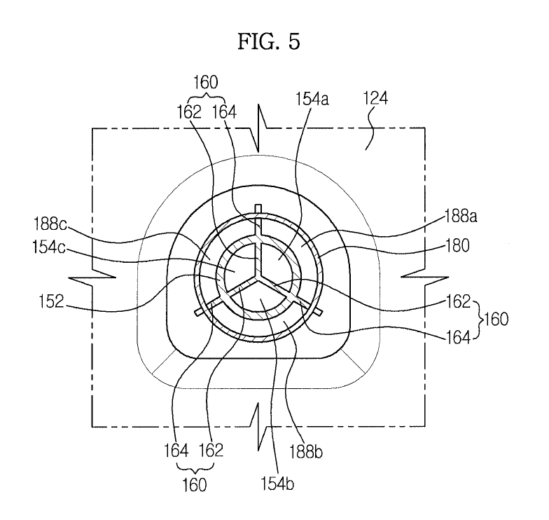

FIG. 2 is an exploded view illustrating the detergent case provided in the washing machine in accordance with an embodiment, FIG. 3 is an exploded view illustrating a liquid detergent discharge device extracted from FIG. 2, FIG. 4 is a cross-sectional view taken along line I-I of FIG. 3, and FIG. 5 is a cross-sectional view taken along line II-II of FIG. 4.

As shown in FIGS. 2 to 5, the detergent case 100 includes a solid detergent storage part 110 to store a detergent in a powdery state composed of fine particles (hereinafter, referred to as a ‘solid detergent’) and a liquid detergent storage part 120 divided from the solid detergent storage part 110 by a diaphragm 112 to store a detergent in a liquid state or a fabric softener (hereinafter, referred to as a ‘liquid detergent’).

The liquid detergent storage part 120 includes a discharge hole 122 through which the liquid detergent is discharged and a liquid detergent discharge device 130 to effectively discharge the liquid detergent stored within the liquid detergent storage part 120. The liquid detergent discharge device 130 includes a siphon pipe 150 communicating with the discharge hole 122 and protruded from a bottom surface 124 of the liquid detergent storage part 120 by a designated length, and a siphon cap 180 connected to the outer portion of the siphon pipe 150.

The siphon pipe 150 is formed in a hollow cylindrical shape, and includes a plurality of partition ribs 160 to divide the siphon pipe 150 into at least two pieces. The plural partition ribs 160 are radially extended from the center C of the siphon pipe 150, pass through a side part 152 of the siphon pipe 150, and protruded to a designated length. The plural partition ribs 160 are divided into inner ribs 162 located at the inside of the side part 152 of the siphon pipe 150, and outer ribs 164 located at the outside of the side part 152 of the siphon pipe 150. That is, some of the partition ribs 160 extended from the center C of the siphon pipe 150 and contacted the inner circumferential surface of the side part 152, form the inner ribs 162, and some of the partition ribs 160 protruded from the outer circumferential surface of the side part 152 by the designated length, form the outer ribs 164.

The outer rib 164 is provided with a holding part 166 in which the siphon cap 180 is held, and the holding part 166 is provided with a holding groove 168 to prevent movement of the siphon cap 180 held in the holding part 166. The holding part 166 has a designated height h so that the siphon cap 180 is separated from the bottom surface 124 of the liquid detergent storage part 120. One end of the outer rib 164 contacts the inner surface of the siphon cap 180 when the siphon cap 180 is connected to the siphon pipe 150.

The plural partition ribs 160 is formed to a greater height than the siphon pipe 150, thus contacting the inner surface of the siphon cap 180 when the siphon cap 180 is connected to the siphon pipe 150.

Although FIGS. 2 to 4 illustrate that intervals between the plural partition ribs 160, thicknesses of the plural partition ribs 160 and thicknesses of pieces of the side part 152 divided by the plural partition ribs 160 are equal or uniform, they may be different according to the liquid detergent discharge performance of the liquid detergent discharge device 130 or characteristics of the liquid detergent to be used, and a detailed description thereof will be given later.

The siphon pipe 150 includes first flow paths 154a, 154b and 154c divided from each other at the inside of the side part 152 by the inner ribs 162. The liquid detergent mixed with wash water is discharged to the outside of the liquid detergent storage part 120 through the first flow paths 154a, 154b and 154c and the discharge hole 122 communicating with the first flow paths 154a, 154b and 154c.

The siphon cap 180 is connected to the outer portion of the siphon pipe 150. The siphon cap 180 includes a side wall 182 having a larger outer diameter than the outer diameter of the siphon pipe 150 to store the siphon pipe 150 so as to connect the siphon pipe 150 to the siphon cap 180, and a cover 184 connected to the upper part of the side wall 182. The side wall 182 and the cover 184 may be integrally formed.

The outer ribs 164 contact the inner circumferential surface of the side wall 182 and the inner ribs 162 contact the inner surface of the cover 184, thus forming second flow paths 188a, 188b and 188c divided from each other. The siphon cap 180 is separated from the siphon pipe 150 by an interval corresponding to the length of the outer ribs 164 protruded from the outer circumferential surface of the side part 152, and the second flow paths 188a, 188b and 188c divided from each other are formed by the inner circumferential surface of the side wall 182, the outer circumferential surface of the side part 152 of the siphon pipe 150 and the neighboring outer ribs 164 provided between the inner circumferential surface of the side wall 182 and the outer circumferential surface of the side part 152 of the siphon pipe 150. The second flow paths 188a, 188b and 188c together with the first flow paths 154a, 154b and 154c form liquid detergent discharge paths.

The lower part of the side wall 182 is held in the holding grooves 168 formed on the holding parts 166, thus being fixed. Since the holding parts 166 are protruded from the bottom surface 124 of the liquid detergent storage part 120 by the designated height h, the siphon cap 180 held in the holding parts 166 is separated from the bottom surface 124 of the liquid detergent storage part 120 by the designated height h. The siphon cap 180 is separated from the bottom surface 124 of the liquid detergent storage part 120, thus forming a liquid detergent inflow hole 192. The liquid detergent inflow hole 192 communicates with the second flow paths 188a, 188b and 188c. The liquid detergent stored within the liquid detergent storage part 120 is introduced into the second flow paths 188a, 188b and 188c through the liquid detergent inflow hole 192.

Thicknesses of parts of the side wall 182 divided by the plural partition ribs 160 may be different according to the liquid detergent discharge performance of the liquid detergent discharge device 130 or characteristics of the liquid detergent to be used.

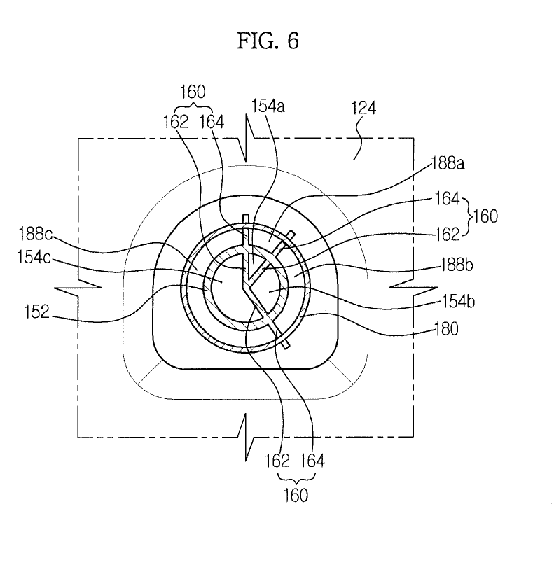

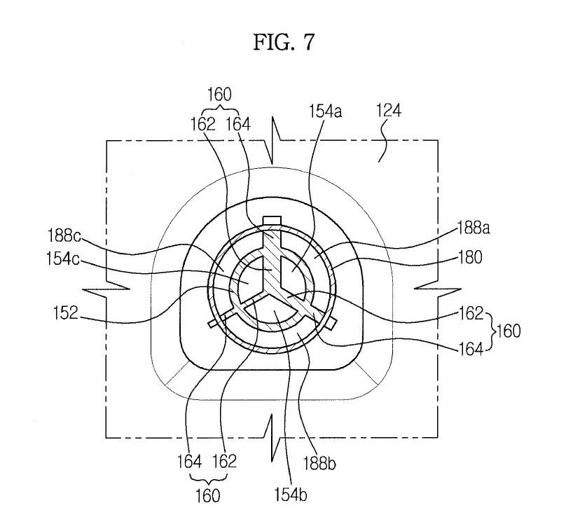

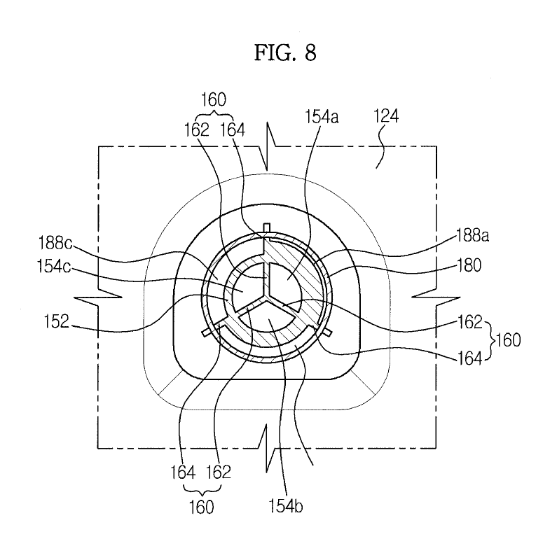

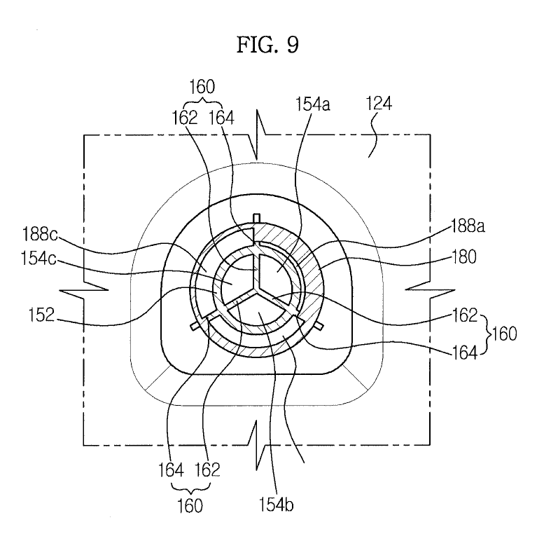

FIG. 6 is a cross-sectional view illustrating a state in which intervals between the partition ribs are different from FIG. 5, FIG. 7 is a cross-sectional view illustrating a state in which thicknesses of the partition ribs are different from FIG. 5, FIG. 8 is a cross-sectional view illustrating a state in which thicknesses of parts of the siphon pipe divided by the partition ribs are different from FIG. 5, and FIG. 9 is a cross-sectional view illustrating a state in which thicknesses of parts of the siphon cap divided by the partition ribs are different from FIG. 5.

The first flow paths 154a, 154b and 154c and the second flow paths 188a, 188b and 188c may be divided into at least two spaces having different cross-sectional areas, and the divided first flow paths 154a, 154b and 154c respectively communicate with the divided second flow paths 188a, 188b and 188c.

If the intervals between the plural partition ribs 160 are different, as shown in FIG. 6, the first flow paths 154a, 154b and 154c having different cross-sectional areas and the second flow paths 188a, 188b and 188c having different cross-sectional areas may be formed, and if the thicknesses of the plural partition ribs 160 are different, as shown in FIG. 7, the first flow paths 154a, 154b and 154c having different cross-sectional areas and the second flow paths 188a, 188b and 188c having different cross-sectional areas may be formed. Further, if the thicknesses of the parts of the siphon pipe 150 divided by the plural partition ribs 160 are different, as shown in FIG. 8, the first flow paths 154a, 154b and 154c having different cross-sectional areas and the second flow paths 188a, 188b and 188c having different cross-sectional areas may be formed, and if the thicknesses of the parts of the siphon cap 180 divided by the plural partition ribs 160 are different, as shown in FIG. 9, the first flow paths 154a, 154b and 154c having different cross-sectional areas and the second flow paths 188a, 188b and 188c having different cross-sectional areas may be formed.

Although FIGS. 6 to 9 illustrate the first flow paths 154a, 154b and 154c having different cross-sectional areas and the second flow paths 188a, 188b and 188c having different cross-sectional areas as being divided by three partition ribs 160 for convenience, the number of the partition ribs 160 may be different according to the liquid detergent discharge performance of the liquid detergent discharge device 130 or characteristics of the liquid detergent to be used.

Hereinafter, a principle of discharging a liquid detergent through the liquid detergent discharge device 130 will be described.

When water is supplied to the liquid detergent storage part 120 through the water supply hoses 50 under the condition that the liquid detergent has been poured into the liquid detergent storage part 120 provided in the detergent case 100, the liquid detergent stored in the liquid detergent storage part 120 is mixed with the water (hereinafter, a mixture of the liquid detergent and the water being referred to as “wash water”), and the level of the wash water continuously increases according to water supply. When the level of the wash water continuously increases and reaches a height H (with reference to FIG. 4) where a siphon effect occurs, the wash water is discharged to the outside of the detergent case 100 through the first flow paths 154a, 154b and 154c and the discharge hole 122 communicating with the first flow paths 154a, 154b and 154c and starts to be introduced into the drum 30.

When the siphonage effect occurs, the wash water is continuously discharged through the liquid detergent discharge device 130 even if water is not supplied through the water supply hosed 50. The wash water stored in the liquid detergent storage part 120 is introduced into the second flow paths 188a, 188b and 188c through the liquid detergent inflow hole 192, flows upward along the second flow paths 188a, 188b and 188c, and then falls along the first flow paths 154a, 154b and 154c. Here, the first flow path 154a and the second flow path 188a communicating with the first flow path 154a, the first flow path 154b and the second flow path 188b communicating with the first flow path 154b, and the first flow path 154c and the second flow path 188c communicating with the first flow path 154c, are respectively divided from each other, and thus wash water passing therethrough does not mix.

When the wash water is continuously discharged so that a designated amount or more of the wash water stored in the liquid detergent storage part 120 is discharged, the siphon effect is stopped in one of the second flow paths 188a, 188b and 188c and wash water stored in the second flow path in which the siphon effect is stopped does not flow to the corresponding first flow path 154a, 154b or 154c and falls to the bottom surface 124 by gravity. Here, in other second flow paths divided from the second flow path in which the siphon effect is stopped, wash water discharge is still carried out without stoppage of the siphon effect.

The siphon effect is more rapidly stopped in the liquid detergent discharge path including the second flow path 188c having a relatively large cross-sectional area. Since the wash water containing the liquid detergent has a designated viscosity, in the case of the second flow path 188a having a relatively small cross-sectional area, frictional force among the inner circumferential surface of the side wall 182 of the second flow path 188a, the outer circumferential surface of the side part 152 and the wash water increases, and thus the wash water stored in the second flow path 188a does not easily fall to the bottom surface 124 by gravity, but in case of the second flow path 188c having a relatively large cross-sectional area, the volume of the wash water stored therein increases and effect of gravity increases more than frictional force, and thus the wash water easily falls to the bottom surface 124.

The wash water fallen to the bottom surface 124 along the second flow path 188c in which the siphon effect is stopped is again introduced into the second flow paths 188a and 188b in which the siphon effect is not stopped, and then falls through the first flow paths 154a and 154b. Thereafter, the siphon effect is firstly stopped in the second flow path 188b having a larger cross-sectional view than the second flow path 188a, the wash water fallen to the bottom surface 124 along the second flow path 188b is introduced into the second flow path 188a in which the siphon effect is not stopped, and then falls through the first flow path 154a. Finally, only the wash water stored in the second flow path 188a having the smallest cross-sectional area falls to the bottom surface 124 and remains in the liquid detergent storage part 120.

Even if the second flow paths 188a, 188b and 188c divided from each other have the same cross-sectional area, the above-described effect is also generated. The reason is that there is actually a fine flow difference due to viscosities or flowing velocities of wash water flowing upward along the second flow paths 188a, 188b and 188c and moving resistances acting on the wash water flowing upward along the inner circumferential surface of the side wall 182 and the outer circumferential surface of the side part 152.

The liquid detergent discharge device 130 in accordance with an embodiment includes the plural liquid detergent discharge paths divided from each other, and thus a siphon effect stoppage time is different according to the plural liquid detergent discharge paths. Therefore, only wash water stored in the second flow path 188a having the smallest cross-sectional area falls to the bottom surface 134, and thus the liquid detergent scarcely remains in the liquid detergent storage part 120 after completion of washing.

Although not shown in the drawings, the liquid detergent discharge device 130 may be provided in the detergent case 100 applied to a fully automatic washing machine having a pulsator as well as a drum washing machine and be used as a liquid detergent supply device.

As is apparent from the above description, a detergent case in accordance with an embodiment effectively discharges a liquid detergent to the outside of the detergent case so that the liquid detergent scarcely remains in the detergent case after completion of washing.

Although a few embodiments of have been shown and described, it would be appreciated by those skilled in the art that changes may be made in these embodiments without departing from the principles and spirit of the invention, the scope of which is defined in the claims and their equivalents.

What is claimed is:

1. A washing machine comprising:
a main body;
a drum disposed in the main body; and
a detergent case mounted in the main body to supply a detergent to the inside of the drum,
wherein the detergent case includes:
a liquid detergent storage part to store a liquid detergent;
a siphon pipe protruded from the bottom of the liquid detergent storage part and including first flow paths divided into at least two spaces; and
a siphon cap connected to the outer portion of the siphon pipe and forming second flow paths divided into at least two spaces.

2. The washing machine according to claim 1, wherein:
the second flow paths are formed between the outer circumferential surface of the siphon pipe and the inner circumferential surface of the siphon cap so that the liquid detergent stored in the liquid detergent storage part flows upward; and
the first flow paths communicate with the second flow paths and are formed at the inside of the siphon pipe so that the liquid detergent having passed through the second flow paths falls to the inside of the drum.

3. The washing machine according to claim 2, further comprising a plurality of partition ribs to divide the siphon pipe,,
wherein the plurality of partition ribs includes:
inner ribs disposed at the inside of the siphon pipe to divide the first flow paths from each other; and
outer ribs disposed between the outer circumferential surface of the siphon pipe and the inner circumferential surface of the siphon cap to divide the second flow paths from each other.

4. The washing machine according to claim 3, wherein the plurality of partition ribs is formed to a greater height than the siphon pipe and thus contacts the inner surface of the siphon cap.

5. The washing machine according to claim 4, wherein each of the outer ribs includes a holding groove in which the siphon cap is held.

6. The washing machine according to claim 2, wherein the first flow paths and the second flow paths are respectively divided into at least two spaces having different cross- sectional areas.

7. The washing machine according to claim 6, wherein the plurality of partition ribs is extended radially from the center of the siphon pipe, and at least one interval between the neighboring plurality of partition ribs is different.

8. The washing machine according to claim 6, wherein a thickness of at least one of the plurality of partition ribs is different.

9. The washing machine according to claim 6, wherein a thickness of at least one part of the siphon pipe divided by the plurality of partition ribs is different.

10. The washing machine according to claim 6, wherein a thickness of at least one part of the siphon cap divided by the plurality of partition ribs is different.

11. A detergent case mounted in a main body of a washing machine to store a detergent, the detergent case comprising:
a liquid detergent storage part provided with a discharge hole to discharge a liquid detergent; and
a liquid detergent discharge device communicating with the discharge hole and provided with at least two liquid detergent discharge paths divided from each other.

12. The detergent case according to claim 11, wherein the liquid detergent discharge device includes:
a liquid detergent discharge pipe provided at a position corresponding to the discharge hole so as to communicate with the discharge hole, and including first flow paths divided into at least two spaces; and
a discharge pipe cap connected to the liquid detergent discharge pipe and forming second flow paths divided into at least two spaces.

13. The detergent case according to claim 12, wherein the first flow paths are formed at the inside of the liquid detergent discharge pipe, and the second flow paths are provided between the outside of the liquid detergent discharge pipe and the inside of the discharge pipe cap.

14. The detergent case according to claim 13, wherein:
the liquid detergent discharge pipe further includes a plurality of partition ribs to divide the first flow paths into at least two spaces having different cross-sectional areas; and
the plurality of partition ribs is extended radially from the center of the liquid detergent discharge pipe and contacts the inner circumferential surface of the discharge pipe cap.

15. The detergent case according to claim 14, wherein the plurality of partition ribs passes through the side surface of the liquid detergent discharge pipe and divides the second flow paths into at least two spaces having different cross-sectional areas.

16. The detergent case according to claim 15, wherein the plurality of partition ribs is formed to a greater height than the liquid detergent discharge pipe and thus contacts the discharge pipe cap.

17. The detergent case according to claim 16, wherein each of the plurality of partition ribs includes a holding part protruded upward from the bottom surface of the liquid detergent storage part so as to separate the discharge pipe cap from the bottom surface.

18. The detergent case according to claim 17, wherein a holding groove to prevent movement of the discharge pipe cap is provided on the holding part.

19. The detergent case according to claim 18, wherein the discharge pipe cap is connected to the holding groove to form a liquid detergent inflow hole through which the liquid detergent stored in the liquid detergent storage part flows into the second flow paths.
